(19) United States
(12) Patent Application Publication
(10) Pub. No.: US 2018/0121978 A1
(43) Pub. Date: May 3, 2018

(54) User-Assisted Processing of Receipts and Invoices

(71) Applicant: MetaBrite, Inc., Mercer Island, WA (US)

(72) Inventors: Court V. Lorenzini, Mercer Island, WA (US); Roy Penn, Seattle, WA (US); Samuel Anthony Lucente, San Francisco, CA (US); Yen-chi Lin, Bellevue, WA (US)

(73) Assignee: MetaBrite, Inc., Mercer Island, WA (US)

(21) Appl. No.: 15/339,897

(22) Filed: Oct. 31, 2016

(51) Int. Cl. G06Q 30/06; G06Q 20/04; G06F 17/30; G06T 7/00; G06K 9/00; G06K 9/46

(52) U.S. Cl. CPC G06Q 30/0603; G06Q 30/0643; G06Q 20/0453; G06F 17/30312; G06T 2207/30108; G06K 9/00442; G06K 9/4671; G06K 2009/4666; G06T 7/0004

(57) ABSTRACT

Systems and methods for user-assisted processing of receipts to capture data from the receipts are presented. Upon receiving an image of a receipt, a receipt processing site processes the content of the receipt to identify potential product items. For those product items that would benefit from user assistance, sets of potential products items (each set corresponding to a particular area of the receipt image called an image box) are gathered and provided to the user in product item data. The product item data includes an image box for each set of potential product items. On a user computing device, a computer user evaluates the sets of potential product items and validates/clarifies the receipt content in view of the image boxes. Updated product item data is returned to the receipt processing site and the updated product data is used to update the product item information that the receipt processing site has generated regarding the received receipt.

### CROSS-REFERENCE

This application is related to co-pending and commonly assigned U.S. patent application Ser. No. 15/238,620, filed Aug. 16, 2016, entitled “Automated Processing of Receipts and Invoices,” the subject matter of which is incorporated herein by reference.

### BACKGROUND

Receiving a receipt as evidence of a sale of goods or provision of services is a ubiquitous part of our life. When you go to a grocery store and make a purchase of one or more items, you receive a receipt. When you purchase fuel for your car, you receive a receipt. Indeed, receipts permeate all aspects of transactions. Generally speaking, receipts evidence a record of a transaction. Receipts itemize the goods or services that were purchased, particularly itemizing what (goods and/or services) was purchased, the quantity of any given item that was purchased, the price of the items) purchased, taxes, special offers and/or discounts generally applied or for particular items, the date (and often the time) of the transaction, the location of the transaction, vendor information, sub-totals and totals, and the like.

There is no set form for receipts—each vendor is free to print a uniquely formed receipt or invoice. Receipts may be printed on full sheets of paper, though many point of sale machines print receipts on relatively narrow slips of paper of varying lengths based, frequently, on the number of items (goods or services) that were purchased. While receipts itemize the items that were purchased, the itemizations are typically terse, cryptic and abbreviated. One reason for this is the limited amount of space that is available for descriptive content, especially on the common, narrow strips of receipt paper. Further, each vendor typically controls the descriptive “language” for any given item. Even different stores of the same vendor will utilize distinct descriptive language from that of other stores. As a consequence, while the purchaser will typically be able to decipher the itemized list of purchased items based on knowledge of what was purchased, a third party will not be able to decipher the information so readily. Indeed, the itemized list of purchased items does not lend itself to fully describing the purchases.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, a computer-implemented method for user-assisted processing of content of a receipt is presented. The method comprises receiving product item data from a receipt processing site at a user computing device. The product item data comprises one or more sets of provisional product items. Moreover, for each set of provisional product items, the provisional product item data comprises a corresponding image box corresponding to an area of a receipt image from which one or more provisional product items of the set of provisional products were identified. A first set of provisional products items and the corresponding image box from the product item data is presented on the computing device to the computer user. The method further includes receiving a user indication with regard to the first set of provisional product items. Based on the user indication, updating the product item data corresponding to the first set of provision product items. Thereafter the updated product item data is returned to the receipt processing site.

According to additional aspects of the disclosed subject matter, a method for user-assisted processing receipts is presented. The method comprises first receiving an image of a receipt. Tokens from content in the image of the receipt are then generated. Potential product items are determined from the generated tokens. More particularly, determining potential product items of the generated tokens includes determining a confidence score for each of the determined potential product items, wherein each confidence score is an indication of a confidence that the potential product item is an actual product item. Sets of potential product items are identified that have confidence scores indicative of user feedback, wherein each set of potential product items correspond to an area of content in the image of the receipt. Product item data are submitted to a computer user for user input, wherein the product item data comprises sets of potential product items with corresponding confidence scores. The product item data further comprises an image box of the corresponding area of content in the image of the receipt. Updated product item data is received from the computer user and the product information regarding the receipt is updated according to the updated product item data received from the user.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 represents an exemplary network environment suitable for implementing aspects of the disclosed subject matter;

FIG. 2 is a block diagram illustrating exemplary processing states of a receipt image to identify product items of the receipt, including user-assisted processing of the receipt;

FIG. 3 is a flow diagram illustrating an exemplary routine, as implemented by a receipt processing site, for processing items of a receipt;

FIG. 4 is a pictorial diagram illustrating an exemplary computer display including various likely product items corresponding to a group of tokens within an image box of a receipt image;

FIG. 5 is a pictorial diagram illustrating an exemplary computer display showing the image box of FIG. 4 in relation to the entire receipt image;

FIG. 6 is a flow diagram illustration an exemplary routine for providing user assistance in receipt content processing;

FIG. 7 is a block diagram illustrating an exemplary computer readable medium encoded with instructions to process receipt information;

FIG. 8 is a block diagram illustrating an exemplary user computing device configured to obtain user information regarding potential product items as described herein; and

FIG. 9 is a block diagram illustrating an exemplary computing device configured to operate as a receipt processing site, such as the receipt processing site illustrated in FIG. 1.

### DETAILED DESCRIPTION

For purposes of clarity and definition, the term “exemplary,” as used in this document, should be interpreted as serving as an illustration or example of something, and it should not be interpreted as an ideal or a leading illustration of that thing. Stylistically, when a word or term is followed by “(s)”, the meaning should be interpreted as indicating the singular or the plural form of the word or term, depending on whether there is one instance of the term/item or whether there is one or multiple instances of the term/item. For example, the term “user(s)” should be interpreted as one or more users.

For purposed of clarity and definition, a “receipt” is a record or evidence of a transaction for goods and/or services that is provided to the purchaser. While many receipts are on a printed page, various aspects of the disclosed subject matter may be suitable applied to receipts that are transmitted electronically, such as images and/or text-based receipts.

The term “receipt image” should be interpreted as that portion of an image of a receipt that represents the subject matter of the receipt to be processed. For purposes of clarity and definition, a receipt image is differentiated from an “image of a receipt” in that an image of a receipt may include extraneous data. For example, a purchaser may take an image of a receipt, where the image includes the receipt, but may also include other subject matter that is not part of the receipt. As will be described in greater detail below, as part of the disclosed subject matter, one or more steps are taken to isolate the receipt image (a subsection of the image of the receipt) such that the receipt image includes only content found on the receipt.

The subsequent description is set forth in regard to processing receipts. While the disclosed subject matter is suitable for advantageously processing receipts, the same subject may be suitably applied to invoices. While a receipt often lists the particular items of purchase, an “invoice” is a document/record that more particularly itemizes a transaction between a purchaser and a seller/vendor. By way of illustration, an invoice will usually include the quantity of purchase, price of goods and/or services, date, parties involved, unique invoice number, tax information, and the like. Accordingly, while the description of the novel subject matter is generally made in regard to processing receipts, it is for simplicity in description and should not be construed as limiting upon the disclosed subject matter. Indeed, the same novel subject matter is similarly suited and applicable to processing invoices.

While aspects of the disclosed subject matter are presented in some order, and particularly in regard to the description of various aspects of processing receipt images to identify purchase data represented by the underlying receipts, it should be appreciated that the order is a reflection of the order of presentation in this document and should not be construed as a required order in which the described steps must be carried out.

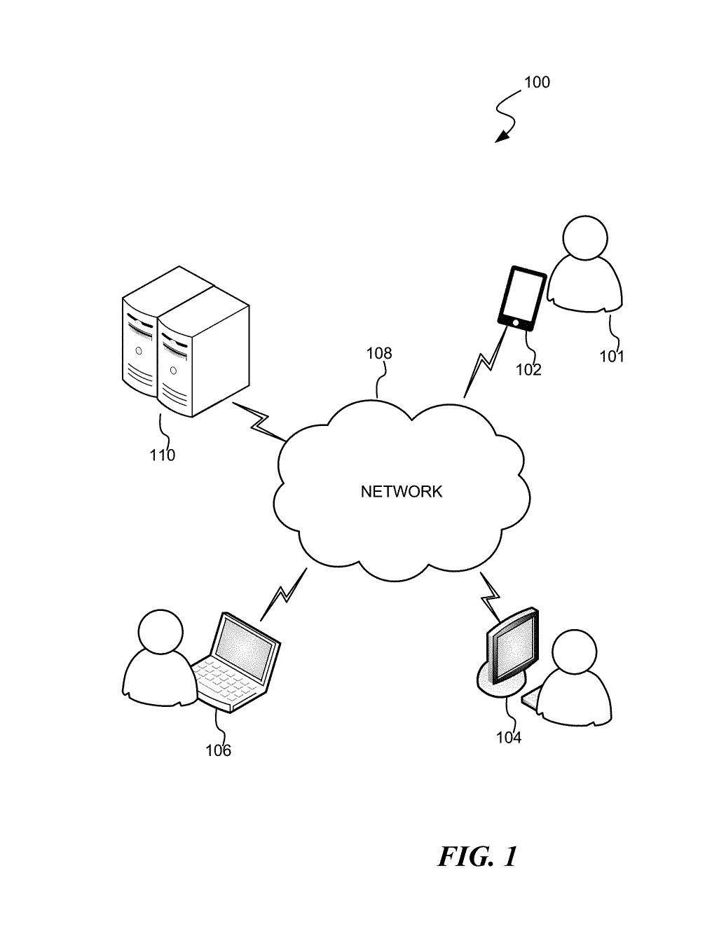

Turning to FIG. 1, FIG. 1 is a pictorial diagram illustrating an exemplary network environment 100 suitable for implementing aspects of the disclosed subject matter, particularly in regard to user-assisted processing of receipts and invoices. The exemplary networked environment 100 includes one or more user computers, such as user computers 102-106, connected to a network 108, such as the Internet, a wide area network or WAN, and the like. User computers include, by way of illustration and not limitation: desktop computers (such as desktop computer 104); laptop computers (such as laptop computer 106); tablet computers (not shown); mobile devices (such as mobile device 102); game consoles (not shown); personal digital assistants (not shown); and the like. User computers may be configured to connect to the network 108 by way of wired and/or wireless connections.

Also connected to the network 108 may be other, various networked sites, including receipt processing site 110. By way of example and not limitation, receipt processing site 110 is configured to receive images and/or records of receipts and invoices and process those receipts in order to identify the product items that are the subject matter of the receipt (or invoice.) A computer user, such as computer user 101, may cause that his/her associated user computer, such as user computer 102, submit an image of a receipt to the receipt processing site 110. Additionally, as will be described in greater detail below, the receipt processing site 110 may communicate over the network 108 with a computer user, such as computer user 101 via user computer 102, in order to obtain user assistance with regard to one or more potential product items of a receipt or invoice.

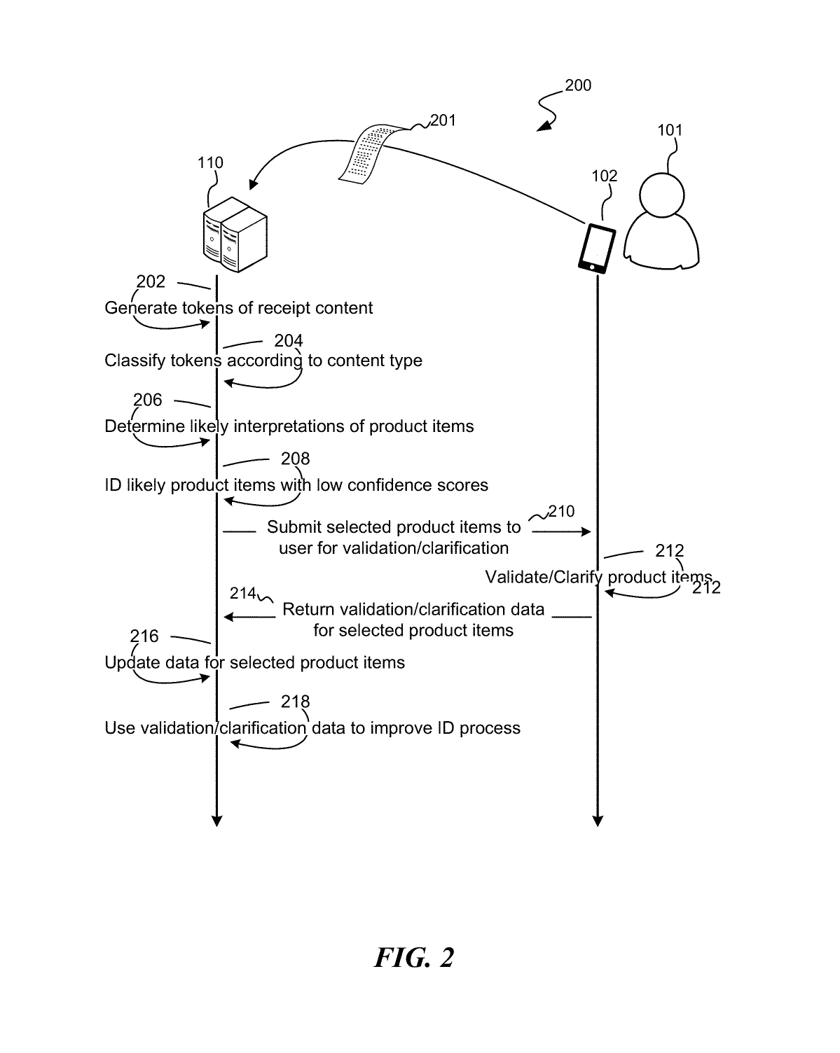

Turning to FIG. 2, FIG. 2 is a block diagram 200 illustrating exemplary processing states of a receipt image 201 to identify product items of the receipt, including user-assisted processing of the receipt. As can be seen, the receipt processing site 110 receives a receipt 201 from a computer user (via user computer 102.) After receiving the receipt image 201, at processing step 202, the receipt processing site 110 generates tokens from the items of content depicted in the receipt image 201. Processing a receipt image, such as receipt image 201, by a receipt processing site is described in greater detail in co-pending and commonly assigned U.S. patent application Ser. No. 15/238,620, filed Aug. 16, 2016, entitled “Automated Processing of Receipts and Invoices,” the subject matter of which is incorporated herein by reference.

After generating tokens from the items of content depicted in the receipt image 201, at processing step 204, the various tokens are classified as to the likely type of token. For example, likely types of classes of tokens make include price, quantity, item description, and the like. After classifying the tokens, at processing step 206 the receipt processing site 110 determines one or more likely product items for a group of tokens corresponding to an item in the receipt. According to aspects of the disclosed subject matter, one or more product items may be identified for any given group of tokens of a receipt. Indeed, in many instances multiple likely product items are identified for a given set of tokens (corresponding to a single item) in a receipt. In determining the likely product items for corresponding to an item in the receipt, a determination of a corresponding score indicating a likelihood or confidence value that a likely product item accurately corresponds to the actual item purchased (or represented) in the receipt. In other words, each likely product item is associated with a corresponding likelihood value, a value/score indicating a confidence that the likely product item accurately represents the item in the receipt. According to various embodiments of the disclosed subject matter, the likelihood/confidence value may be based on a range of values, such as 0 to 100, where a value of 0 represents the least confidence that the likely product item accurately represents the corresponding item in the receipt, and where a value of 100 represents the highest level of confidence that the likely product item accurately represents the corresponding item in the receipt.

After identifying likely product items, at processing step 208 a determination is made as to those likely products items whose likelihood/confidence score fall below a particular threshold—i.e., that the processing by the receipt processing site 110 has a low confidence in the identified likely product items. After identifying these lower scoring likely product items, at processing step 210 the likely product items along with information showing the particular location in the receipt image from which the tokens were generated and the items identified, are provided to the computer user that submitted the receipt for clarification and/or verification.

As shown in FIG. 2, at processing step 212, the computer user validates and/or clarifies what is meant by a particular set/group of tokens. Indeed, as will be discussed in greater detail below, validation and clarification entail the computer user identifying or selecting the actual product item corresponding to the particular location from which the receipt processing site 110 identified the one or more likely product items. After the computer user validates or clarifies the product items, at processing step 214 the information is returned to the receipt processing site.

At processing step 216, the receipt processing site 110 updates the information regarding the various product items and at processing step 218 the receipt processing site utilizes the information in an automated, machine learning process as sample data for improving the identification of future groups of tokens.

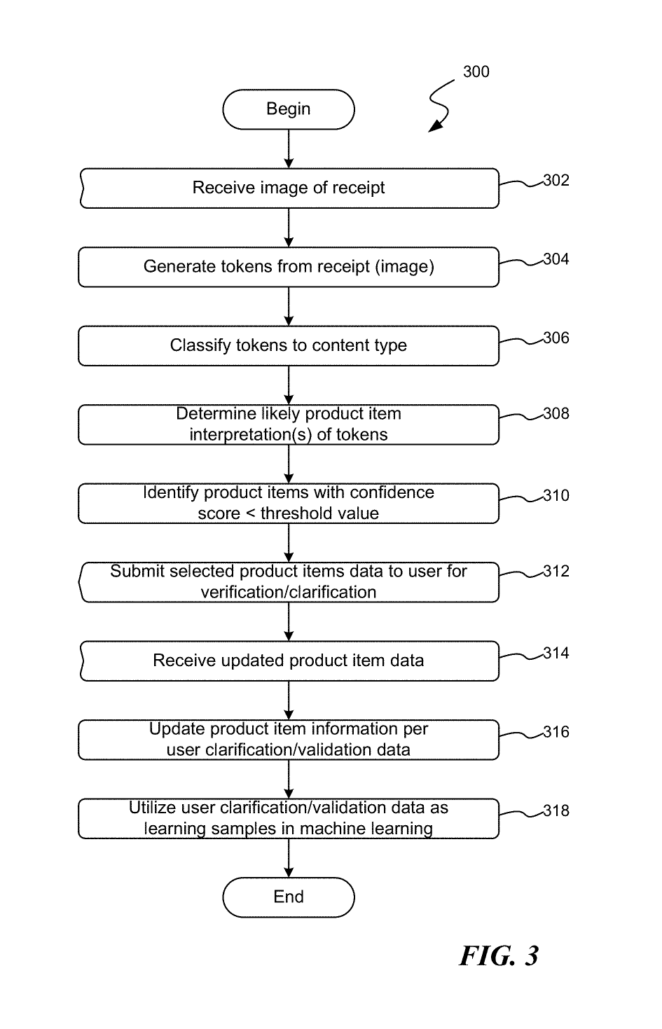

Turning to FIG. 3, FIG. 3 is a flow diagram illustrating an exemplary routine 300, as implemented by a receipt processing site 110, for processing items of a receipt. Beginning at block 302, the receipt processing site receives a receipt image (or, in various embodiments, an electronic record of a receipt or invoice) from a computer user, such as computer user 101. At block 304, the receipt content is processed (e.g., image processing, OCR scanning, etc.) in order to generate tokens corresponding to the receipt content.

At block 306 the generated tokens are evaluated (including evaluated in view of the position of the token in the receipt) and are classified as to a likely interpretation. For example, after the evaluation some of the tokens may be classified as price tokens (i.e., representing a price value), quantity tokens, descriptive content tokens, UPC (Universal Product Code) or SKU (Stock Keeping Unit), and the like. After classifying the various tokens, at block 308 the receipt processing site 110 determines one or more likely product items for a given set or group of tokens. According to aspects of the disclosed subject matter, each of the determined likely product items is associated with a likelihood or confidence score, indicating a confidence value of the receipt processing site with regard to the accuracy or likelihood that the likely product item represents the actual product item. These likelihood/confidence scores are based on information such as ambiguities among the tokens, matching distances to known product items, unknown or previously un-encountered tokens, the distinctiveness of a vendor in describing items on a receipt, and the like. As discussed in regard to processing step 208 above, the confidence values/scores may be based on ranges of values, such as 0 to 100.

At block 310, those product items whose confidence score (or confidence scores) fall below a predetermined threshold value are identified. By way of a non-limiting example, for those product items of a receipt where the confidence scores of all of the likely product item fall below 75 (assuming a scale of 0 to 100), those product items (or their likely product item interpretations) are viewed as falling below the predetermined threshold and are therefore selected for submission to the computer user. Additionally and/or alternatively, there may be cases in which multiple potential product items have a confidence score above a particular confidence threshold. Accordingly, in those instances—as well as others—it may be advantageous to have the computer user clarify/validate a particular potential product item as the actual product item for a particular group of tokens (that corresponds to a particular area of the receipt.) Additionally, while the confidence scores may be evaluated against a single confidence threshold and according to various aspects of the disclosed subject matter, there may be a plurality of confidence thresholds and a first item of a receipt may be evaluated against a first predetermined threshold while a second item of that same receipt may be evaluated against a second predetermined threshold. These thresholds and the determination as to which threshold to use may depend upon the types of elements/items that are being processed, whether the elements/items are common and/or frequently purchased elements/items, whether or not a shop-keeper unit (SKU) is available, and the like. Moreover, while these confidence thresholds may be predetermined in regard to an iteration of processing the items of a given receipt, these confidence thresholds may be dynamically determined for the receipt at the beginning of any given iteration of processing or reprocessing of a receipt. The confidence thresholds may be based on information gathered from processing items of a given receipt, from user (manual) input, from machine learning feedback, and the like.

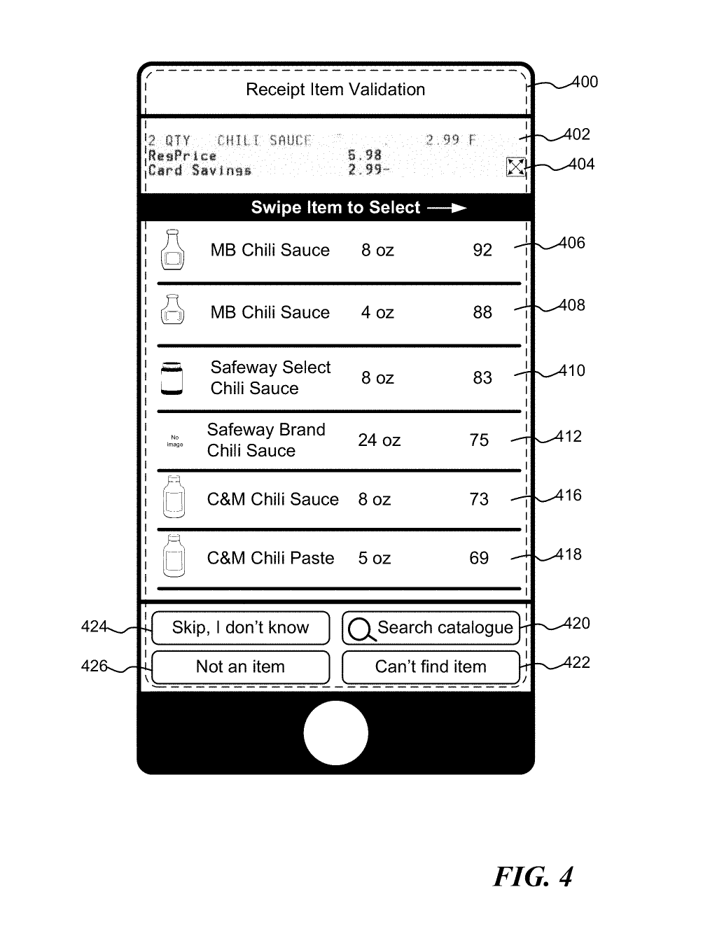

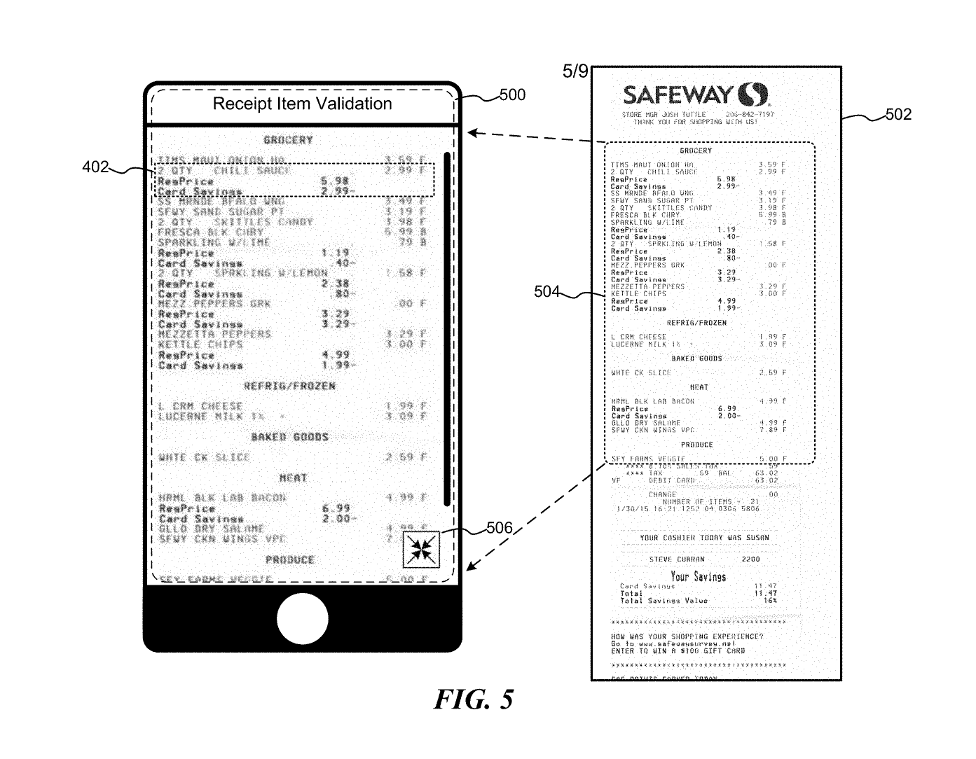

At block 312, those identified likely product items that fall below the predetermined threshold are then submitted to the computer user (that submitted the receipt to the receipt processing site) for validation and/or clarification. According to aspects of the disclosed subject matter, in addition to the list of likely product items and their corresponding confidence scores, each “to-be-identified” product item also includes the image box of the receipt image from which the tokens were interpreted to generate the corresponding one or more likely product items. With further reference to FIGS. 4 and 5, FIG. 4 is a pictorial diagram illustrating an exemplary computer display 400 including various likely product items corresponding to a group of tokens within an image box 402 of a receipt image. Similarly, FIG. 5 is a pictorial diagram illustrating an exemplary computer display 500 showing the image box 402 of FIG. 4 in relation to the entire receipt image 502. By way of illustration, in order to identify the actual product item from receipt image 502 corresponding to image box 402, at block 312 the likely product items (as shown as likely product items 406-418 in computer display 400) are sent to the computer user for validation and/or clarification.

At block 314, the user clarification/validation data is received from the computer user. According to aspects of the disclosed subject matter, the user clarification/validation data includes information that identifies the actual product item of the corresponding image box, or that provides other clarifying or validating information regarding the subject matter of the corresponding image box. This other information may include an indication that the subject matter is not a product item, that the computer user doesn't know what the product item of the image box is, that the computer user is unable to find the actual product item of the image box in a database/catalogue of product items, and the like.

At block 316, after receiving the user clarification/validation data, the product item information that the receipt processing site 110 currently maintains regarding the receipt is updated according to the received user clarification/validation data. At block 318, in addition to simply updating the product item information that is maintained by the receipt processing site 110, the receipt processing site may optionally utilize the clarification/validation data received from the computer user 101 as training information for improving the machine learning techniques employed by the receipt processing site for identifying future product items. Moreover, while FIG. 3 indicates that routine 300 terminates at this point with regard to processing the receipt, in various optional embodiments, after having updated the product item information from the clarification/validation data as well as updating the machine learning model, the entire process may be re-executed in order to more accurately identify the content of the received receipt.

Regarding the various steps set forth in regard to routine 300 of FIG. 3, a more detailed description of some of the steps, including receipt processing and generating tokens from the content is set for in co-pending application “Automated Processing of Receipts and Invoices” mentioned above.

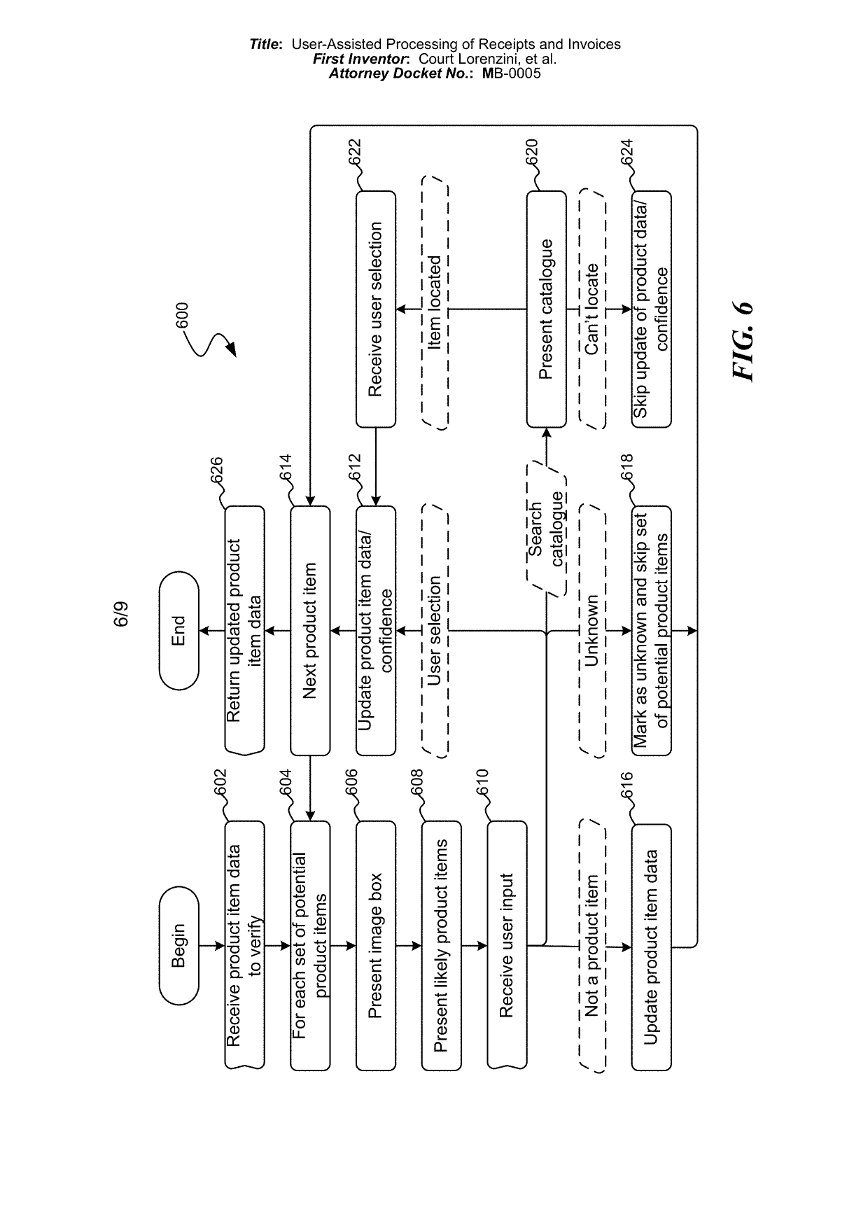

While routine 300 describes various activities of the receipt processing site 110 in processing the content items of a receipt in conjunction with the computer user, FIG. 6 is a flow diagram illustration an exemplary routine 600 for providing user assistance in receipt content processing. Beginning at block 602, the computer user 101 receives product item data corresponding to one or more sets of likely product items of a receipt. According to various embodiments of the disclosed subject matter and by way of illustration, this product item data may be provided by way of an app or application executing on a computing device (such as the computer user's mobile computing device or desktop computing device) indicating a request from the receipt processing site 110 with regard to the corresponding receipt(s). As an alternative embodiment, an email or other type of message may be delivered to the computer user 101 with the product item data. Further still, this data may be made available as the computer user attempts to process additional receipts with the receipt processing site 110.

According to aspects of the disclosed subject matter, each set of potential product items includes one or more potential product items corresponding to an area within a receipt, which area the receipt processing site 110 has interpreted as corresponding to an actual product/receipt item. As indicated above, each potential product item of a set is associated with a score, typically but not exclusively assigned by the receipt processing site 110, indicating the likelihood that the particular potential product item accurately identifies the actual product item. While there may be only a single potential product item for any given set, in many instances the receipt processing site 110 may identify multiple likely/potential product items for a particular area within a receipt (corresponding to a group or collection of generated tokens) and is seeking verification/clarification of the actual product item from among the various potential product items. According to aspects of the disclosed subject matter, the product item data includes, for each set of potential products, an image box, i.e., information including or referencing an image of that area of a receipt from which the potential product items were generated.

At block 604, for each set of potential product items, an iteration loop is begun. This loop enables the user to process all of the various sets of potential product items. At block 606, the image box, such as image box 402 of FIG. 4, is presented as a part of the presentation of the potential product items to the computer user. At block 608, the one or more potential product items of the currently iterated set are also presented. In this manner, both the potential product items as well as an image of the receipt from which the potential product items were generated are presented to the user. In addition to the image box and the potential product items, an image of each potential product item may also be presented to further assist the user in identifying the actual product item. The confidence score associated with individual potential product items may also be presented to the computer user 101.

At block 610, the routine 600 receives computer user input with regard to the currently iterated set of product items. As will be appreciated from FIGS. 4 and 6, the computer user input may include one of several responses, including (by way of illustration and not limitation) a selection of the actual product item, an indication that the image box does not present a product item, an indication that the user does not know/remember what the actual product item is, an indication that the actual product item cannot be found in the receipt processing site's catalog of items, and a request to search the receipt processing site's catalog of product items.

If the user input corresponds to a selection, which may be indicated by any number of user interactions such as tapping an entry (such as entry 406 or 408), swiping an entry, clicking on an entry, and the like, at block 612 the product information data regarding the actual product item is updated according to the computer user selection. A confidence value may also be updated—e.g., to 100%—to reflect the computer user's selection. Thereafter, at block 614, a next set of potential product items is processed and the routine 600 returns to block 604 to continue the iteration of sets. In the alternative that there are no more sets, the routine 600 proceeds to block 626 as will be discussed below.

If the user input corresponds to an indication that the subject matter of the image box 402 is not an actual product item, at block 616 the product item data/information regarding this particular set of potential product items is updated and the routine proceeds to block 614 to continue the iteration as discussed above. A computer user may indicate that the subject matter of the image box 402 is not an actual product item according to various user interactions including interaction with a user control, such as user control 426 or a drop down menu item (not shown), in order to provide this indication.

In the event that the computer user input corresponds to an indication that the subject matter of the image box 402 is unknown to the computer user, at block 618 the set of potential product items may be marked as being unknown and the set of potential product items is skipped. The routine 600 then proceeds to block 614 to continue the iteration of the sets of potential product items. A computer user may indicate that the subject matter of the image box 402 is unknown according to various user interactions including interaction with a user control, such as user control 424 or a drop down menu item (not shown), and the like in order to provide this indication.

In the event that the computer user input corresponds to an indication that the computer user will search for the actual product item (perhaps an indication that the current list of potential product items are all incorrect), at block 620 the receipt processing site's catalog may be presented to the computer user for searching and identification. At block 622, a user selection of a product item from the catalog causes the routine to proceed to block 612 where the product information data regarding the actual/selected product item is updated. The routine 600 then proceeds to block 614 to continue the iteration of the sets of potential product items. If, however, the actual product item is not found in the receipt processing site's catalog, at block 624 the computer user's indication is received (i.e., not in the catalog) and the set of potential product items is updated to indicate that the item is not found and the routine 600 proceeds to block 614 to continue the iteration of the sets of potential product items. Indicating that a corresponding product item is not found in the receipt processing site's catalog may be according to various user interactions including interaction with a user control, such as user control 422, a drop down menu item (not shown), and the like in order to provide this indication. Similarly, requesting a search of the receipt processing site's catalog may be according to various user interactions including interaction with a user control, such as user control 420, a drop down menu item (not shown), and the like in order to provide this indication.

The routine 600 continues processing the sets of potential product items until there are no more sets to process. On this condition, the routine proceeds from block 614 to block 626 where the updated product information, as determined according to the various computer user selections, is provided to the receipt processing site. Thereafter, the routine 600 terminates.

In addition to the various user interactions with regard to particular sets of potential product items, the computer user may also advantageously view the image box 402 in the context of the entire receipt image. By way of illustration and not limitation, by selecting user control 404 of FIG. 4, the display area of the computing device may be replaced (or shown additionally) with an image of the entire receipt, with the image box indicated within the receipt. FIG. 5 illustrates the expanded view 500 of the entire receipt 502. As can be seen, image box 402 is indicated in the expanded view 500 thereby providing a greater context of the particular item of the image box to the computer user. By way of illustration, a computer user may return to the selection view, as shown as view 402 of FIG. 4, by interacting with the contract control 506.

Regarding routines 300 and 600 described above, as well as other processes describe herein, while these routines/processes are expressed in regard to discrete steps, these steps should be viewed as being logical in nature and may or may not correspond to any specific actual and/or discrete steps of a given implementation. Also, the order in which these steps are presented in the various routines and processes, unless otherwise indicated, should not be construed as the only order in which the steps may be carried out. Moreover, in some instances, some of these steps may be combined and/or omitted. Those skilled in the art will recognize that the logical presentation of steps is sufficiently instructive to carry out aspects of the claimed subject matter irrespective of any particular development or coding language in which the logical instructions/steps are encoded.

Of course, while these routines include various novel features of the disclosed subject matter, other steps (not listed) may also be carried out in the execution of the subject matter set forth in these routines. Those skilled in the art will appreciate that the logical steps of these routines may be combined together or be comprised of multiple steps. Steps of the above-described routines may be carried out in parallel or in series. Often, but not exclusively, the functionality of the various routines is embodied in software (e.g., applications, system services, libraries, and the like) that is executed on one or more processors of computing devices, such as the computing device described in regard FIG. 6 below. Additionally, in various embodiments all or some of the various routines may also be embodied in executable hardware modules including, but not limited to, system on chips (SoC's), codecs, specially designed processors and or logic circuits, and the like on a computer system.

As suggested above, these routines/processes are typically embodied within executable code modules comprising routines, functions, looping structures, selectors and switches such as if-then and if-then-else statements, assignments, arithmetic computations, and the like. However, as suggested above, the exact implementation in executable statement of each of the routines is based on various implementation configurations and decisions, including programming languages, compilers, target processors, operating environments, and the linking or binding operation. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in routines embodied within applications (also referred to as computer programs), apps (small, generally single or narrow purposed applications), and/or methods, these aspects may also be embodied as computer-executable instructions stored by computer-readable media, also referred to as computer-readable storage media, which are articles of manufacture. As those skilled in the art will recognize, computer-readable media can host, store and/or reproduce computer-executable instructions and data for later retrieval and/or execution. When the computer-executable instructions that are hosted or stored on the computer-readable storage devices are executed by a processor of a computing device, the execution thereof causes, configures and/or adapts the executing computing device to carry out various steps, methods and/or functionality, including those steps, methods, and routines described above in regard to the various illustrated routines. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. While computer-readable media may reproduce and/or cause to deliver the computer-executable instructions and data to a computing device for execution by one or more processors via various transmission means and mediums, including carrier waves and/or propagated signals, for purposes of this disclosure computer readable media expressly excludes carrier waves and/or propagated signals.

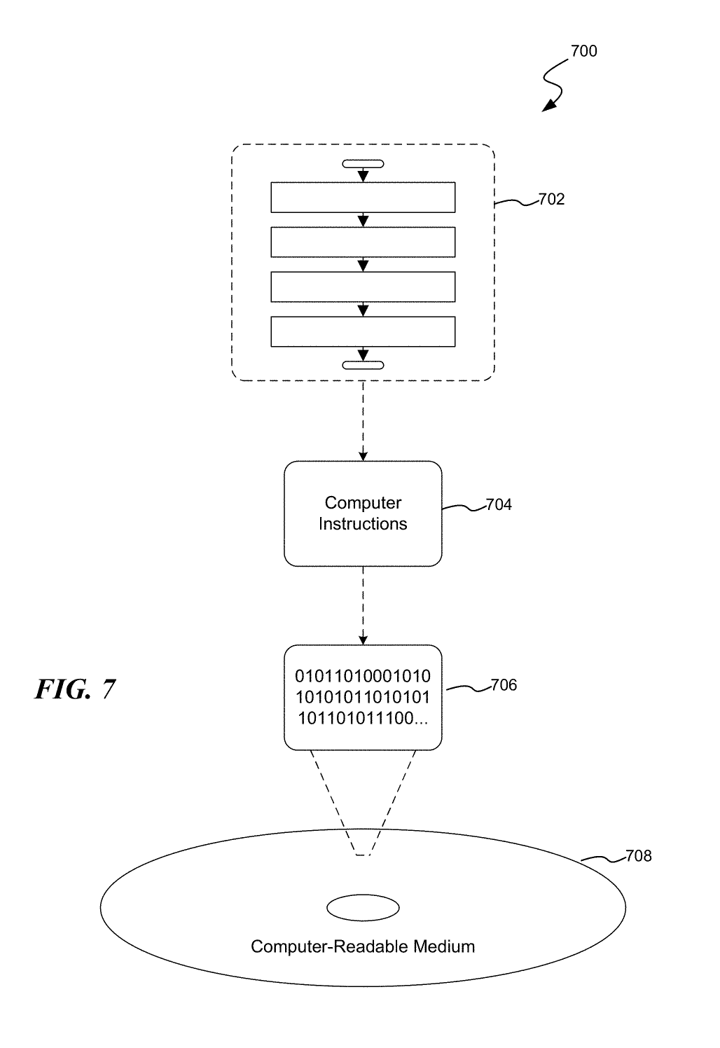

Turning to FIG. 7, FIG. 7 is a block diagram illustrating an exemplary computer readable medium encoded with instructions to process receipts as described above. More particularly, the implementation 700 comprises a computer-readable medium 708 (e.g., a CD-R, DVD-R or a platter of a hard disk drive), on which is encoded computer-readable data 706. This computer-readable data 706 in turn comprises a set of computer instructions 704 configured to operate according to one or more of the principles set forth herein. In one such embodiment, the processor-executable instructions 704 may be configured to perform a method, such as at least some of the exemplary methods 300 and 600, for example. In another such embodiment, the processor-executable instructions 704 may be configured to implement a system, such as at least some of the exemplary system 800 or 900, as described below. Many such computer-readable media may be devised, by those of ordinary skill in the art, which are configured to operate in accordance with the techniques presented herein.

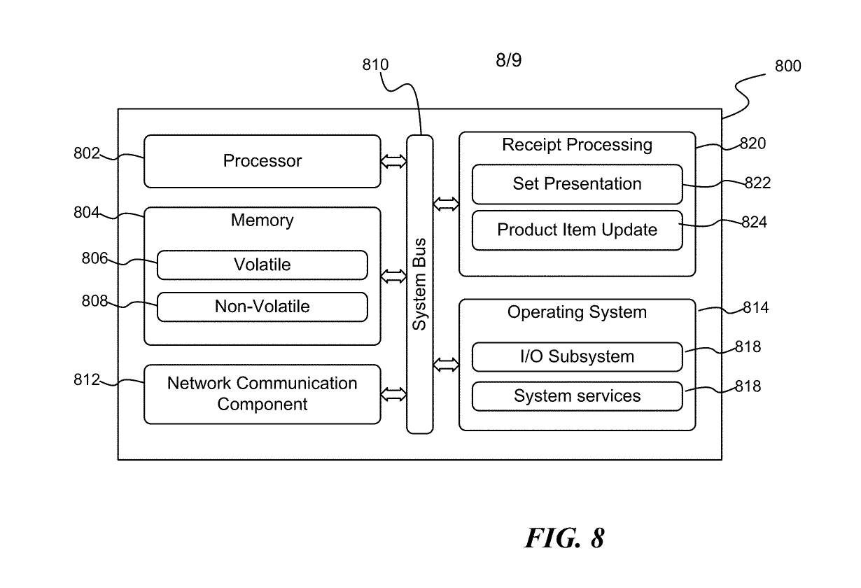

Turning now to FIG. 8, FIG. 8 is a block diagram illustrating an exemplary user computing device 800 configured to obtain user information regarding potential product items as described herein. The exemplary computing device 800 includes one or more processors (or processing units), such as processor 802, and a memory 804. The processor 802 and memory 804, as well as other components, are interconnected by way of a system bus 810. The memory 804 typically (but not always) comprises both volatile memory 806 and non-volatile memory 808. Volatile memory 806 retains or stores information so long as the memory is supplied with power. In contrast, non-volatile memory 808 is capable of storing (or persisting) information even when a power supply is not available. Generally speaking, RAM and CPU cache memory are examples of volatile memory 806 whereas ROM, solid-state memory devices, memory storage devices, and/or memory cards are examples of non-volatile memory 808.

Exemplary computing devices suitable as user computing devices for providing user information/feedback (validation and clarification) of sets of potential product items include, by way of illustration and not limitation, mobile computing devices, tablet computing devices, laptop computers, desktop computers, mini- and mainframe computers, thin client devices, and the like.

As will be appreciated by those skilled in the art, the processor 802 executes instructions retrieved from the memory 804 (and/or from computer-readable media, such as computer-readable media 700 of FIG. 7) in carrying out various functions of automated receipt processing as described above. The processor 802 may be comprised of any of a number of available processors such as single-processor, multi-processor, single-core units, and multi-core units.

Further still, the illustrated computing device 800 includes a network communication component 812 for interconnecting this computing device with other devices and/or services over a computer network, such as computer network 108 of FIG. 1. The network communication component 812, sometimes referred to as a network interface card or NIC, communicates over a network using one or more communication protocols via a physical/tangible (e.g., wired, optical, etc.) connection, a wireless connection, or both. As will be readily appreciated by those skilled in the art, a network communication component, such as network communication component 812, is typically comprised of hardware and/or firmware components (and may also include or comprise executable software components) that transmit and receive digital and/or analog signals over a transmission medium (i.e., the network.)

The exemplary user computing device 800 also includes an operating system 814 that provides functionality and services on the user computing device. These services include an I/O subsystem 816 that comprises a set of hardware, software, and/or firmware components that enable or facilitate inter-communication between a user of the computing device 800 and the processing system of the computing device 800. FIGS. 4 and 5 illustrate exemplary views presented by an underlying I/O subsystem of the computing device. Indeed, via the I/O subsystem 814 a computer user may provide input via one or more input channels such as, by way of illustration and not limitation, touch screen/haptic input devices, buttons, pointing devices, audio input, optical input, accelerometers, and the like. Output or presentation of information may be made by way of one or more of display screens (that may or may not be touch-sensitive), speakers, haptic feedback, and the like. As will be readily appreciated, the interaction between the computer user and the computing device 800 is enabled via the I/O subsystem 814 of the user computing device. Additionally, system services 818 provide additional functionality including location services, timers, interfaces with other system components such as the network communication component 812, and the like.

Further still, the exemplary user computing device 800 includes a receipt processing module 820. In execution and/or operation, the receipt processing module 820 receives sets of product item data/information from the receipt processing site 110, coordinates the validation and/or clarification of the data through the various processes described above, and returns the updated (validated and/or clarified) data back to the receipt processing site. The receipt processing module 820 includes a set presentation component 822 that presents the various sets of potential product items (such as shown in view 400 of FIG. 4), displays the image box (such as image box 402), and captures user selections and/or other feedback with regard to the actual product items of a given set. The product item update component 824 receives the user input regarding the sets of potential product items and updates the received data accordingly.

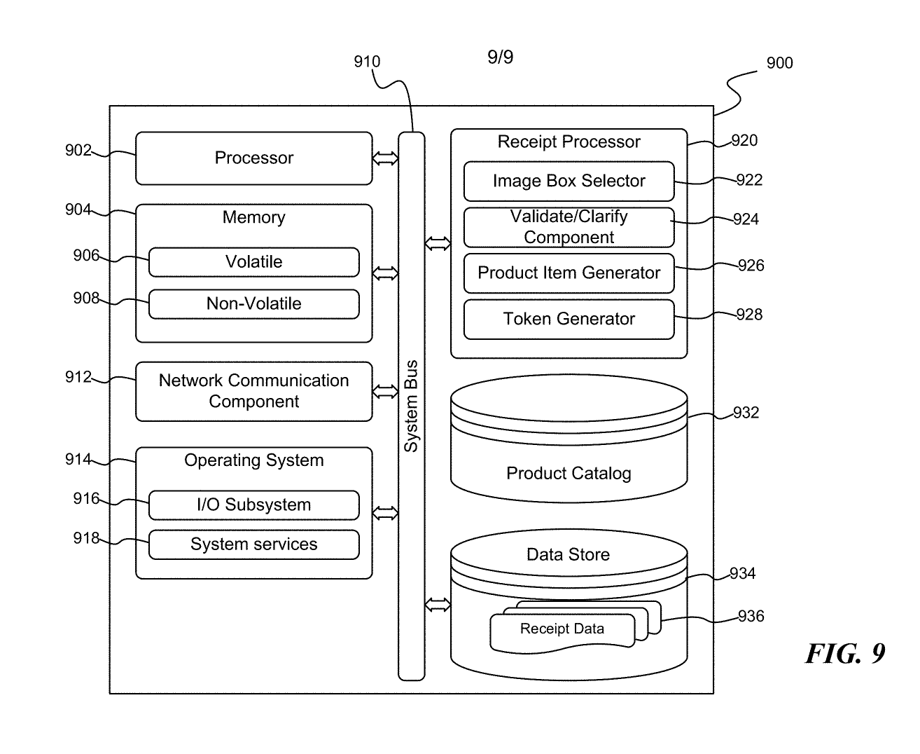

Turning to FIG. 9, FIG. 9 is a block diagram illustrating an exemplary computing device 900 configured to operate as a receipt processing site, such as receipt processing site 110. The exemplary computing device 900 includes one or more processors (or processing units), such as processor 902, and a memory 904. The processor 902 and memory 904, as well as other components, are interconnected by way of a system bus 910. The memory 904 typically (but not always) comprises both volatile memory 906 and non-volatile memory 908. Volatile memory 906 retains or stores information so long as the memory is supplied with power.

As will be appreciated by those skilled in the art and as discussed above in regard to FIG. 8, the processor 902 executes instructions retrieved from the memory 904 (and/or from computer-readable media, such as computer-readable media 700 of FIG. 7) in carrying out various functions of automated receipt processing as described above. The processor 602 may be comprised of any of a number of available processors such as single-processor, multi-processor, single-core units, and multi-core units.

Further still, the illustrated computing device 900 includes a network communication component 912 for interconnecting this computing device with other devices and/or services over a computer network, such as network 108 of FIG. 1. The network communication component 912, sometimes referred to as a network interface card or NIC, communicates over a network using one or more communication protocols via a physical/tangible (e.g., wired, optical, etc.) connection, a wireless connection, or both. As will be readily appreciated by those skilled in the art, a network communication component, such as network communication component 912, is typically comprised of hardware and/or firmware components (and may also include or comprise executable software components) that transmit and receive digital and/or analog signals over a transmission medium (i.e., the network.)

The exemplary user computing device 900 also includes an operating system 914 that provides functionality and services on the user computing device. These services include an I/O subsystem 916 that comprises a set of hardware, software, and/or firmware components that enable or facilitate inter-communication between a user of the computing device 800 and the processing system of the computing device 800. Indeed, via the I/O subsystem 914 a computer operator may provide input via one or more input channels such as, by way of illustration and not limitation, touch screen/haptic input devices, buttons, pointing devices, audio input, optical input, accelerometers, and the like. Output or presentation of information may be made by way of one or more of display screens (that may or may not be touch-sensitive), speakers, haptic feedback, and the like. As will be readily appreciated, the interaction between the computer user and the computing device 900 is enabled via the I/O subsystem 914 of the user computing device. Additionally, system services 618 provide additional functionality including location services, timers, interfaces with other system components such as the network communication component 912, and the like.

The exemplary computing device 900 also includes a receipt processor module 920 that, in execution, manages the processing of receipts. As discussed above in regard to FIG. 3, after receiving a receipt (or image of a receipt or invoice), the receipt processor module 920 generates tokens from the content of the receipt according to a token generator component 928. The tokens are then classified (by the token generator 928 or another component) and a product item generator 926 generates potential product items for the various actual product items of the receipt. In generating these potential product items, a confidence score is associated with each potential product item.

A validate/clarify component 924 identifies those sets of potential product items that require validation and/or clarification from the computer user. A image box, such as image box 402, is identified by an image box selector 922 for each set of potential product items that require validation and/or clarification from the computer user and the potential product item data is sent to the computer user for validation/clarification.

The receipt processor 920, or one of its sub-components, transmits the data to the computer user as well as receives the data. Upon receipt, the receipt processor 920 updates the data according to the user feedback, as stored in receipt data 936 a data store 934. The exemplary computing device 900 still further includes a product catalog 932 identifying known product items such that a computer user may search the catalog for an actual item.

Regarding the various components of the exemplary computing devices 800 and 900, those skilled in the art will appreciate that many of these components may be implemented as executable software modules stored in the memory of the computing device, as hardware modules and/or components (including SoCs—system on a chip), or a combination of the two. Indeed, components may be implemented according to various executable embodiments including executable software modules that carry out one or more logical elements of the processes described in this document, or as a hardware and/or firmware components that include executable logic to carry out the one or more logical elements of the processes described in this document. Examples of these executable hardware components include, by way of illustration and not limitation, ROM (read-only memory) devices, programmable logic array (PLA) devices, PROM (programmable read-only memory) devices, EPROM (erasable PROM) devices, and the like, each of which may be encoded with instructions and/or logic which, in execution, carry out the functions described herein.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method, the method comprising:
receiving product item data from a receipt processing site, the product item data comprising one or more sets of provisional product items and, for each set of provisional product items, and further comprising a corresponding image box corresponding to an area of a receipt image from which one or more provisional product items of the set of provisional products were identified;
presenting a first set of provisional products items and the corresponding image box from the product item data;
receiving a user indication with regard to the first set of provisional product items;
updating the product item data corresponding to the first set of provision product items according to the user indication; and
returning the updated product item data to the receipt processing site.

2. The computer-implemented method of claim 1, wherein each provisional product item of a set of provisional product items of the product item data is associated with a confidence score comprising a confidence value that the provisional product item accurately represents the actual product item of the image box.

3. The computer-implemented method of claim 1, wherein the user indication comprises a selection of a first of the one or more provisional product items as the actual product item represented in the image box.

4. The computer-implemented method of claim 1, wherein updating the product item data corresponding to the first set of provision product items according to the user indication comprises indicating the selected provisional product item is the actual product item.

5. The computer-implemented method of claim 1, wherein the user indication comprises an indication that the content represented in the image box is not a product item.

6. The computer-implemented method of claim 1, wherein the user indication comprises an indication that the content represented in the image box is an unknown product item to the computer user.

7. The computer-implemented method of claim 1, wherein the user indication comprises a request to view a product catalog of product items.

8. The computer-implemented method of claim 7 further comprising, upon receiving the user indication of a request to view a product catalog:
displaying a list of product items of a product catalog to the user; and
receiving a user selection of a product item from the product catalog, wherein the user selection is indicative of the actual product item represented in the image box.

9. The computer-implemented method of claim 8, wherein updating the product item data corresponding to the first set of provision product items according to the user indication comprises indicating that the user selection of the product item from the product catalog is the actual product item represented in the image box.

10. The computer-implemented method of claim 7 further comprising, upon receiving the user indication of a request to view a product catalog:
displaying a list of product items of a product catalog to the user; and
receiving a user indication that the actual product item represented in the image box is not found.

11. The computer-implemented method of claim 10, wherein updating the product item data corresponding to the first set of provision product items according to the user indication comprises indicating that the actual product item represented in the image box is not found in the updated product item data.

12. A computer-readable medium bearing computer-executable instructions which, when executed on a computing device comprising at least a processor, carry out a method on the computing device, the method comprising:
receiving product item data from a receipt processing site, the product item data comprising one or more sets of provisional product items and, for each set of provisional product items, and further comprising a corresponding image box corresponding to an area of a receipt image from which one or more provisional product items of the set of provisional products were identified;
presenting a first set of provisional products items and the corresponding image box from the product item data;
receiving a user indication with regard to the first set of provisional product items;
updating the product item data corresponding to the first set of provision product items according to the user indication; and
returning the updated product item data to the receipt processing site.

13. The computer-readable medium of claim 12, wherein the user indication comprises a selection of a first of the one or more provisional product items as the actual product item represented in the image box.

14. The computer-readable medium of claim 12, wherein the user indication comprises an indication that the content represented in the image box is not a product item.

15. The computer-readable medium of claim 12, wherein the user indication comprises an indication that the content represented in the image box is an unknown product item to the computer user.

16. The computer-readable medium of claim 12, wherein the method further comprises classifying the generated tokens according to a content type.

17. The computer-readable medium of claim 12, wherein the user indication comprises a request to view a product catalog of product items.

18. The computer-readable medium of claim 17, wherein the method further comprises, upon receiving the user indication of a request to view a product catalog:
displaying a list of product items of a product catalog to the user; and
receiving a user selection of a product item from the product catalog, wherein the user selection is indicative of the actual product item represented in the image box.

19. The computer-readable medium of claim 17, wherein the method further comprises, upon receiving the user indication of a request to view a product catalog:
displaying a list of product items of a product catalog to the user; and
receiving a user indication that the actual product item represented in the image box is not found.

20. A computer-implemented method for processing receipts, the method comprising:
receiving an image of a receipt;
generating tokens from content in the image of the receipt;
determining potential product items of the generated tokens, wherein determining potential product items of the generated tokens includes determining a confidence score for each of the determined potential product items, wherein each confidence score is an indication of a confidence that the potential product item is an actual product item;
identifying sets of potential product items having confidence scores less than a threshold value, wherein each set of potential product items correspond to an area of content in the image of the receipt;
submitting product item data to a computer user for user input, wherein the product item data comprises sets of potential product items with corresponding confidence scores, and further comprises an image box of the corresponding area of content in the image of the receipt;
receiving updated product item data from the computer user;
update product information regarding the receipt according to the updated product item data received from the user; and
storing the potential items of content in association with the image of the receipt in a data store.
